(19) United States
(12) Patent Application Publication
(10) Pub. No.: US 2023/0385307 A1
(43) Pub. Date: Nov. 30, 2023

(54) ENABLING COMMUNICATION BETWEEN MULTIPLE DISPARATE SYSTEMS

(71) Applicant: Hop.dev, Inc., San Francisco, CA (US)

(72) Inventor: KRISTOPHER WHITE, San Francisco, CA (US)

(21) Appl. No.: 17/821,868

(22) Filed: Aug. 24, 2022

Related U.S. Application Data
(60) Provisional application No. 63/345,553, filed on May 25, 2022.
(60) Provisional application No. 63/371,154, filed on Aug. 11, 2022.

(51) Int. Cl. G06F 16/28; G06F 16/22

(52) U.S. Cl. CPC G06F 16/288; G06F 16/2272

(57) ABSTRACT

The disclosed system receives a request to establish a communication channel between a first system among the multiple systems and the second system among the multiple systems. The first system includes a first record with a first UUID unknown to the second system. The second system includes a second record associated with a second UUID unknown to the second system. The first record and the second record are equivalent. The system creates a UUID unique in the first and second systems. A first mapping between the UUID and the first UUID is stored in the first system and a second mapping between the UUID and the second UUID is stored in the second system. The system preserves security between the first system and the second system by enabling exchange of information associated with the first record and the second record across the communication channel using the UUID.

### CROSS-REFERENCE TO RELATED APPLICATIONS

This application claims priority to the benefit of the U.S. provisional patent application Ser. No. 63/345,553 filed May 25, 2022, and the U.S. provisional patent application Ser. No. 63/371,154 filed Aug. 11, 2022, both of which are incorporated herein by reference in their entirety.

### BACKGROUND

A disparate system, or a disparate data system, is a computer data processing system that is designed to operate independently of other computer data processing systems and to operate as a fundamentally distinct system. A problem arises when multiple disparate databases need to communicate with each other, but they do not know each other's record nomenclature.

### BRIEF DESCRIPTION OF THE DRAWINGS

Detailed descriptions of implementations of the present invention will be described and explained through the use of the accompanying drawings.

FIG. 1 shows a system providing a central universally unique identifier (UUID) index.

FIG. 2 shows two databases communicating with each other, where each database has a local UUID index.

FIG. 3 shows two databases communicating with each other, where the database receiving the request does not have a local UUID index.

FIG. 4 shows two databases communicating with each other, where the database initiating the request does not have a local UUID index.

FIG. 5 shows two databases, neither of which has a local UUID index.

FIG. 6 is a flowchart to enable communication between multiple databases having disparate indices.

FIG. 7 shows a system to enable secure communication between two or more disparate databases.

FIG. 8 shows a hierarchy of the various UUIDs.

FIG. 9 is a flowchart of a method to enable communication between multiple systems.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed system enables communication between system A and system B using a hierarchy of universally unique identifiers (UUIDs). The system receives a request to establish a communication channel between system A and system B, where the system A includes a record A associated with a UUID A, where the UUID A is unknown to the system B. The systems A and B can each include one or more databases having disparate indices. The system B includes a record B associated with a UUID B, where the UUID B is unknown to the system A. The record A and the record B are equivalent and can be records referring to the same user. The system can create a UUID unique in the system A and the system B. A mapping A between the universally unique identifier and the UUID A can be stored in the system A and a mapping B between the universally unique identifier and the UUID B can stored in the system B. The system can preserve security between the system A and the system B by enabling exchange of information associated with the record A and the record B across the communication channel using the universally unique identifier, without disclosing the UUID A to the system B and the UUID B to the system A.

Further, the disclosed system enables communication between multiple databases. The system can create a central universally unique identifier index, where the central universally unique identifier index maps multiple local identifiers associated with multiple records in the multiple databases to a universally unique identifier. The universally unique identifier is unique across the multiple databases. The multiple databases include a first database without a universally unique identifier index. The first database among the multiple databases includes a record having a first identifier. A second database among the multiple databases includes an equivalent record having a second identifier, where the first identifier and the second identifier are different, and the equivalent record in the second database includes information about a same event as the record in the first database. The universally unique identifier in the central universally unique identifier index represents the first identifier and the second identifier.

The system can receive a request from a first database among the multiple databases to obtain an equivalent record from a second database among the multiple databases, where the request includes the first identifier associated with the record in the first database. The system can determine whether the identifier is a local identifier unique to the first database. Upon determining that the identifier is the local identifier unique to the first database, based on the central universally unique identifier index, the system converts the local identifier to a first unique identifier. The system can send the first unique identifier to the first database.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Enabling Communication Between Multiple Databases Having Disparate Indices

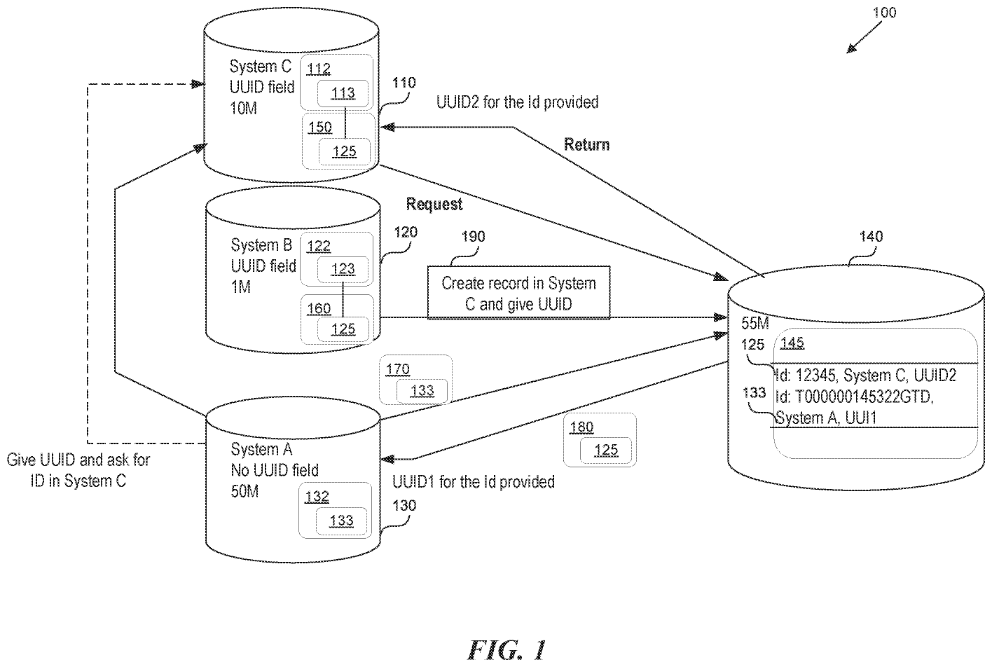

FIG. 1 shows a system providing a central universally unique identifier (UUID) index. The system 100 can include multiple databases 110, 120, 130, and a server 140 providing a central UUID index 145.

The multiple databases 110, 120, 130 can store millions of records 112, 122, 132, each of which has a unique local identifier (ID) 113, 123, 133, even if the records 112, 122, 132 are equivalent to each other. The unique local IDs 113, 123, 133 are unique to their respective databases 110, 120, 130, but may or may not be unique to the whole system including the multiple databases 110, 120, 130. Equivalent records in different databases 110, 120, 130 do not store the same information, but they are related to each other because they contain different information related to the same event, such as a visit to a doctor's office. For example, the database 110 can store information about a doctor in the record 112, the database 120 can store information about the patient in the record 122, and the database 130 can store the invoices generated from the patient's visit to the doctor in the record 132. Consequently, the databases 110, 120, 130, even though they store equivalent information, cannot communicate with each other because databases 120, 130 do not know the unique local identifier 113 associated with the record 112 stored in the database 110.

To solve this problem, the system 100 generates a UUID index 145 that uniquely identifies each record 112, 122, 132 across all the databases 110, 120, 130. The records 112, 122, 132 that are equivalent to each other can have the same UUID 125. The UUID index 145 can include the unique local ID 113, 123, 133 for all records 112, 122, 132 in all databases 110, 120, 130, and can map the unique local ID to the corresponding UUID 125, which is unique across all the databases 110, 120, 130. For example, as shown in FIG. 1, the UUID index 145 can include the value of ID 133, which can be T000000145322GTD, System A, UUI1, and can map the ID 133 to UUID 125, having the value of 12345, System C, UUID2.

Modern databases 110, 120 can store the UUID index 150, 160 of the records contained in the databases 110, 120 directly in the database 110, 120, respectively. The modern databases 110, 120 can include a Salesforce database, Redshift, Snowflake, MySQL, Postgres, etc. By storing the UUID index 150, 160 directly in the database, the databases 120, 130 can communicate directly with each other. For example, if the database 120 wants to retrieve the record 132 equivalent to the record 122, the database 120 can obtain the UUID 125 of the record 122 from the UUID index 150 and can query the database 130 for the record having the UUID 125. Upon receiving the query, the database 130 can return the record having the UUID 125, namely the record 132.

A unique aspect of the system 100 is that it can enable modern databases 110, 120 to communicate with legacy databases 130. The database 130 can be a legacy database, such as a mainframe database, including DB2, IMS, CA Datacom, CA IDMS, SQL/DS and Adabas, that cannot store the UUID index equivalent to UUID indices 150, 160. Consequently, the database 130 cannot retrieve equivalent records 122, 132 by interacting with the databases 110, 120. Instead, the database 130 can send a request 170 to the server 140 storing the central UUID index 145. The request 170 can include the ID 133 of the record 132. The ID 133 can have the value of T000000145322GTD, System A, UUI1.

The server 140 can respond to the request 170 by sending the response 180, including the UUID 125 of the ID 133 to the database 130. The records 112, 122, 132 can have the same UUID 125 because the records are equivalent. The UUID 125 can have the value of 12345, System C, UUID2. Upon receiving the new UUID 125 of the equivalent records 112, 122, the database 130 can then directly interact with the databases 110, 120 based on the UUID 125. Alternatively, the database 130 can interact with the databases 110, 120 through the server 140. For example, the database 130 can request the ID in the database 110, 120 of a record having the UUID 125.

Databases 110, 120, 130 can interact with each other through the server 140. For example, the database 120 can send a request 190 to create a record in the database 110, 130 based on the UUID 125. Similarly, the databases 120, 130 can interact with the other databases 110, 120, 130 using the server 140 by supplying the local ID 123, 133 and asking for the corresponding UUID 125.

In the disclosed system 100, the databases 110, 120 may or may not store the UUID indices 150, 160 locally. If the UUID indices 150, 160 are not stored locally, the databases 110, 120 can query the server 140 for the UUID of a local ID 113, 123. The system 100 can have a single central UUID index 145, or a limited number of UUID indices, namely, one central UUID index 145 and one UUID index 150, 160 for each database 110, 120. By contrast, other systems in addition to the UUID indices 145, 150, 160 can have multiple UUID indices for each database. For example, in other systems the database 110 can have a UUID index for records contained in the database 110, a second UUID index for records contained in the database 120, and a third UUID index for records contained in the database 130. If there are 20 mutually communicating databases, each database in the system can have 20 UUID indices, for a total of 400 indices. By contrast, the disclosed system 100 would have one or at most 21 UUID indices. The significantly lower number of UUID indices uses less memory, makes updating the UUID indices 145, 150, 160 computationally cheaper, and is less prone to error.

Further, if a database 110 wants to regenerate local IDs 113 with the current system, updating needs to occur only for the central UUID index 145 and/or the UUID index 150, if the database 110 has a local UUID index 150. By contrast, in other systems, if the database 110 regenerates the local IDs 113, all the UUID indices in the databases 120, 130 need to be regenerated in addition to updating the local IDs 113. If there are 20 mutually communicating databases, the current system needs to perform either one or at most two updates to two UUID indices 145, 150. By contrast, other systems would need to perform 21 UUID index updates. Consequently, the disclosed system reduces computation time and is less prone to error.

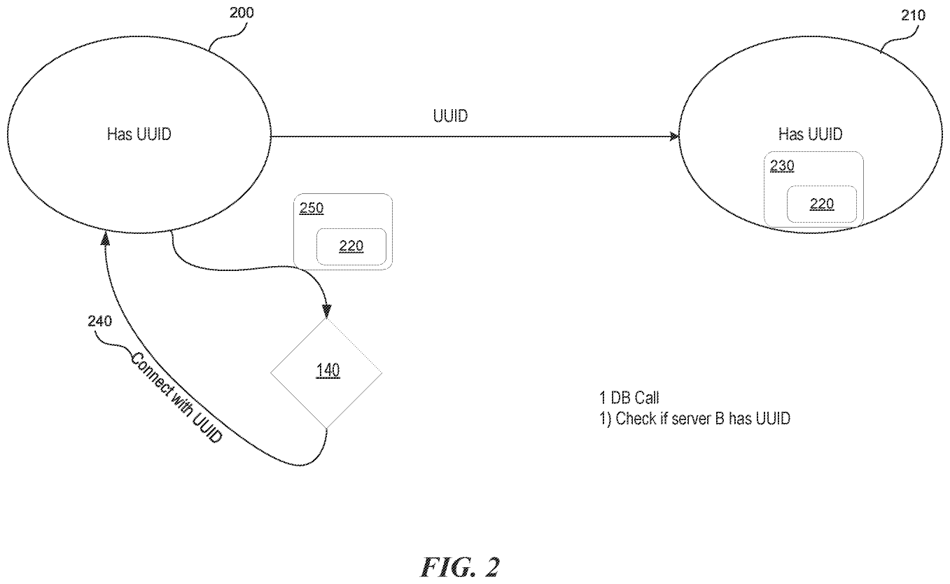

FIG. 2 shows two databases 200, 210 communicating with each other, where each database has a local UUID index. The database 200 may want to request a record having the UUID 220 from the database 210. Prior to initiating communication with the database 210, the database 200 can send a message 250 to the server 140 querying whether the database 210 has a local UUID index 230. Since the database 210 has the local UUID index 230, the server 140 can send a confirmation 240 to the database 200 to communicate with the database 210 using the UUID 220. Upon receiving the confirmation 240, the database 200 can request the record having the UUID 220 from the database 210.

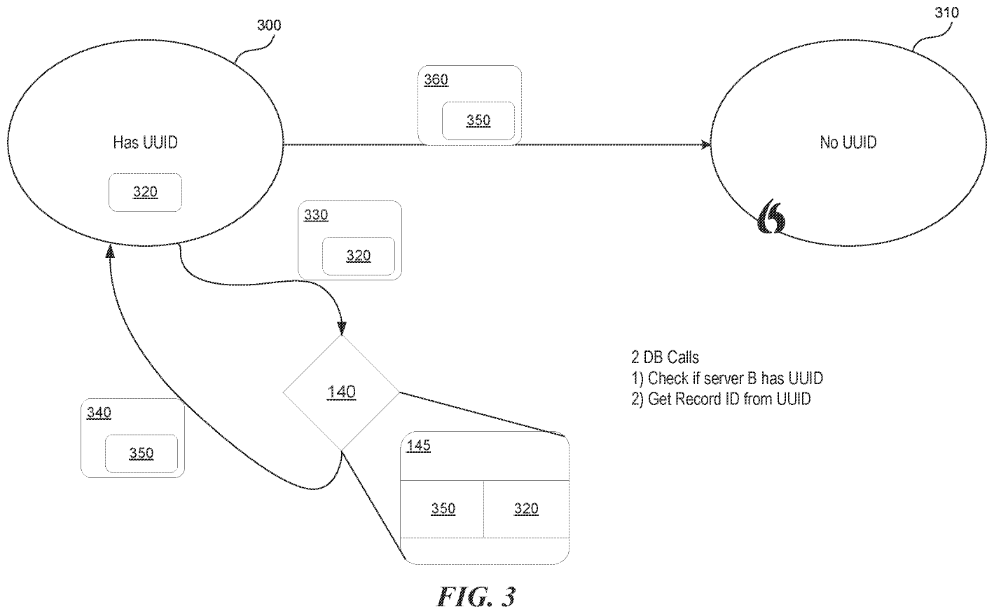

FIG. 3 shows two databases 300, 310 communicating with each other, where the database receiving the request does not have a local UUID index. The database 300 may want to request a record having the UUID 320 from the database 310. Prior to initiating communication with the database 310, the database 300 can send a message 330 to the server 140 querying whether the database 310 has a local UUID index including the UUID 320.

The server 140 can confirm that the database 310 does not have a local UUID index, and can use the central UUID index 145 to determine the local ID 350 corresponding to the UUID 320. The server 140 can send a response 340 including an indication that the database 310 does not have a local UUID index, and also including the ID 350 unique and local to the database 310 and corresponding to the UUID 320. Upon receiving the response 340, the database 300 can send a request 360 including the ID 350 to the database 310. The database 310 can then respond with the contents of the record having the local ID 350.

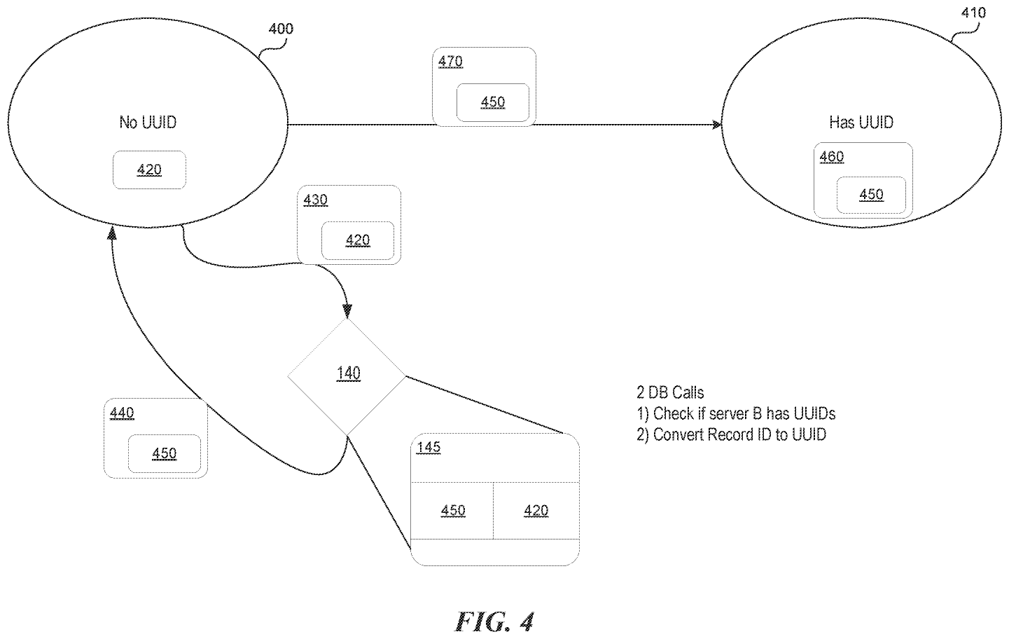

FIG. 4 shows two databases 400, 410 communicating with each other, where the database initiating the request does not have a local UUID index. The database 400 may want to request a record from the database 410 equivalent to a record having a local ID 420. However, the database 410 does not recognize the local ID 420. Consequently, the database 400 sends a request 430 to the server 140. The request 430 includes the local ID 420 of the record in the database 400.

The server 140 can use the central UUID index 145 to determine the UUID 450 corresponding to the local ID 420. The server 140 can send a response 440 including an indication that the database 410 has a local UUID index 460, and also including the UUID 450 corresponding to the equivalent record in the database 410. Upon receiving the response 440, the database 400 can send a request 470 including the UUID 450 to the database 410. The database 410 can respond with the contents of the record having the UUID 450.

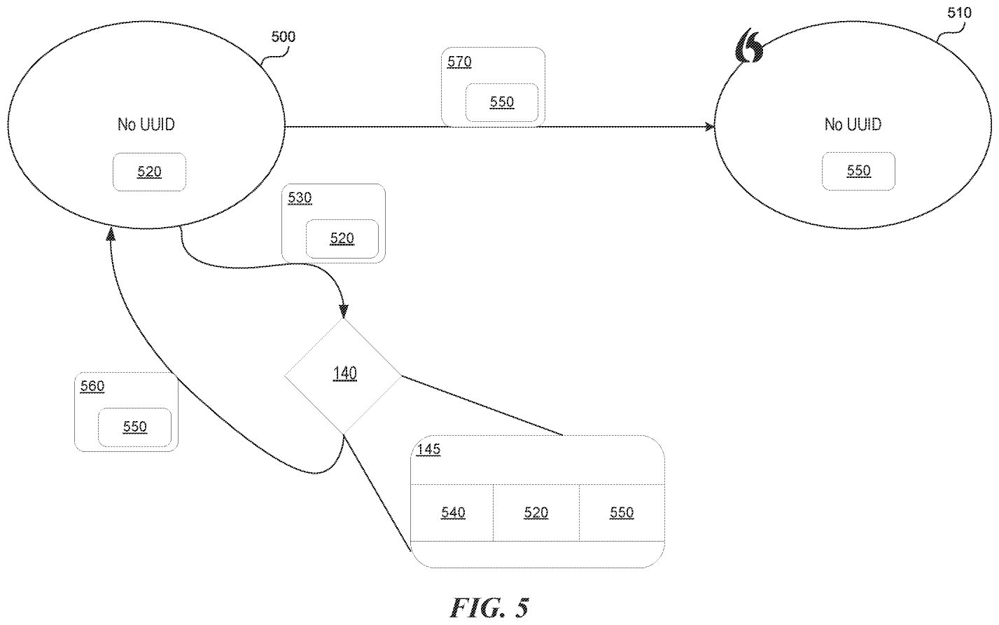

FIG. 5 shows two databases 500, 510, neither of which has a local UUID index. The database 500 may want to request a record from the database 510 equivalent to a record having a local ID 520. However, the database 510 does not recognize the local ID 520. Consequently, the database 500 can send a request 530 to the server 140. The request 530 can include the local ID 520 of the record in the database 500.

The server 140, based on the local ID 520, can determine the UUID 540 associated with the local ID 520. The server 140 can also determine that the database 510 does not have the local UUID index and can determine, using the central UUID index 145, the local ID 550 of the equivalent record in the database 510.

The server 140 can send a response 560 including an indication that the database 510 does not have a local UUID index, and also including the local ID 550 of the equivalent record in the database 510. Upon receiving the response 560, the database 500 can send a request 570 including the local ID 550 to the database 510. The database 510 can respond with the record having the local ID 550.

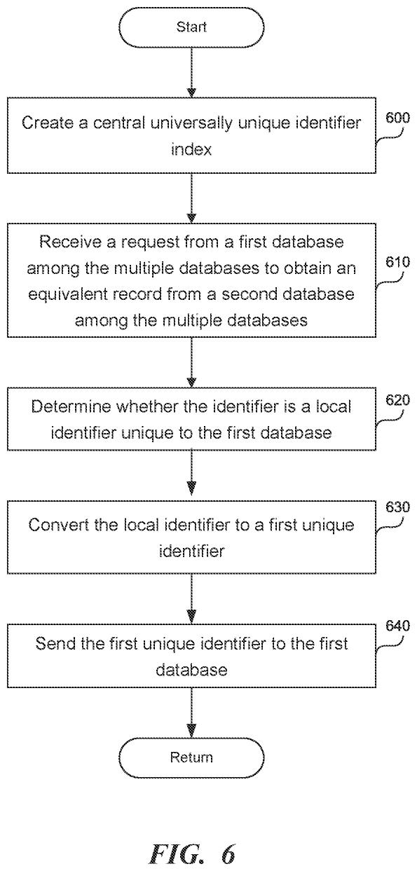

FIG. 6 is a flowchart to enable communication between multiple databases having disparate indices. In step 600, a hardware or software processor executing instructions described in this application can create a central universally unique identifier index mapping multiple local identifiers associated with multiple records in the multiple databases to a universally unique identifier, which is unique across the multiple databases. The multiple databases can include a first database including a record having a first identifier, and a second database including an equivalent record having a second identifier. The equivalent record in the second database includes information about a same event as the record in the first database. The first database may not include a first universally unique identifier index. For example, the first database may be a legacy database. The first identifier and the second identifier can be different. The universally unique identifier in the central universally unique identifier index can relate the first identifier and the second identifier by mapping the first identifier to the second identifier, and vice versa.

In step 610, the processor can receive a request from the first database among the multiple databases to obtain the equivalent record from the second database among the multiple databases. The request can include the first identifier associated with the record in the first database. The identifier can be a universally (i.e., globally) unique identifier or can be a local identifier new to the first database.

In step 620, the processor can determine whether the identifier is a local identifier unique to the first database. To make the determination, the processor can compare the identifier to the central universally unique identifier index, and determine whether the identifier is globally unique, or specific to the first database.

In step 630, upon determining that the identifier is the local identifier unique to the first database, based on the central universally unique identifier index, the processor can convert the local identifier to a first unique identifier. In step 640, the processor can send the first unique identifier to the first database.

The processor can reduce a memory footprint of the UUID indices by creating at most the central universally unique identifier index and multiple universally unique identifier indices, where one, e.g., a first, universally unique identifier index among the multiple universally unique identifier indices corresponds to one, e.g., a first, database among the multiple databases. In other words, the number of universally unique identifier indices is the same as the number of multiple databases. Each universally unique identifier index can map a multiplicity of local identifiers associated with a first multiplicity of records in the first database to a first multiplicity of universally unique identifiers. The first multiplicity of universally unique identifiers is unique across the multiple databases. The first multiplicity of universally unique identifiers can be stored at the first database. The processor can receive an indication that the first multiplicity of local identifiers changed. The processor can reduce processor cycles needed to propagate the change by updating at most the central universally unique identifier index. In other words, in the current system, the processor can update only one universally unique identifier index, namely, the central universally unique identifier index. By contrast, in other database systems having N databases, each database stores N universally unique identifier indices, one for each database in the system. In that case, to update the local indices in one database requires at least N updates to N other indices.

The processor can receive a message from the second database querying whether the first database includes a first universally unique identifier index mapping a first multiplicity of local identifiers associated with a first multiplicity of records in the first database to a first multiplicity of universally unique identifiers. The second database can include a second universally unique identifier index mapping a second multiplicity of local identifiers associated with the second multiplicity of records in the second database to a second multiplicity of universally unique identifiers. The second multiplicity of universally unique identifiers are unique across the multiple databases. The processor can determine whether the first database includes the first multiplicity of universally unique identifiers. Upon determining that the first database includes the first multiplicity of universally unique identifiers, the processor can send a confirmation to the second database that the first database includes the first multiplicity of universally unique identifiers.

The processor can receive a message from the second database querying whether the first database includes a first universally unique identifier index mapping a first multiplicity of local identifiers associated with a first multiplicity of records in the first database to a first multiplicity of universally unique identifiers. The second database can include a second universally unique identifier index mapping a second multiplicity of local identifiers associated with the second multiplicity of records in the second database to a second multiplicity of universally unique identifiers. The second multiplicity of universally unique identifiers is unique across the multiple databases. The message can include a second universally unique identifier among the second multiplicity of universally unique identifiers. The second universally unique identifier identifies a second record among the second multiplicity of records and a first equivalent record associated with the first database. The second universally unique identifier is unique across the multiple databases. The processor can determine whether the first database includes the first multiplicity of universally unique identifiers. Upon determining that the first database does not include the first multiplicity of universally unique identifiers, based on the second universally unique identifier, the processor can retrieve from the central universally unique identifier index a first local identifier of the first equivalent record associated with the first database. The processor can send to the second database a message including the first local identifier and an indication that the first database does not include the first multiplicity of universally unique identifiers.

The processor can receive a message from the first database querying whether the second database includes a second universally unique identifier index mapping a second multiplicity of local identifiers associated with a second multiplicity of records in the second database to a second multiplicity of universally unique identifiers. The message can include the first identifier associated with the record in the first database. The multiple databases include a first database without a first universally unique identifier index. In other words, the first database can include an index of local identifiers associated with local records. The processor can determine whether the second database includes the second universally unique identifier index. Upon determining that the second database includes the second universally unique identifier index, based on the central universally unique identifier index, the processor can retrieve from the central universally unique identifier index a second universally unique identifier associated with the identifier. The processor can send to the first database a message including the second universally unique identifier and an indication that the second database includes the second universally unique identifier index.

The processor can receive a message from the first database querying whether the second database includes a second universally unique identifier index mapping a second multiplicity of local identifiers associated with a second multiplicity of records in the second database to a second multiplicity of universally unique identifiers. The message can include the first identifier associated with the record in the first database. The first database can contain only local indices, and can be without a first universally unique identifier index. The first identifier associated with the record in the first database can be a local identifier. The processor can determine whether the second database includes the second universally unique identifier index. Upon determining that the second database does not include the second universally unique identifier index, based on the central universally unique identifier index, the processor can retrieve from the central universally unique identifier index a second local identifier associated with the identifier, where the second local identifier uniquely identifies the equivalent record in the second database. The processor can send to the first database a message including the second local identifier and an indication that the second database does not include the second universally unique identifier index.

### Enabling Communication Between Multiple Disparate Systems

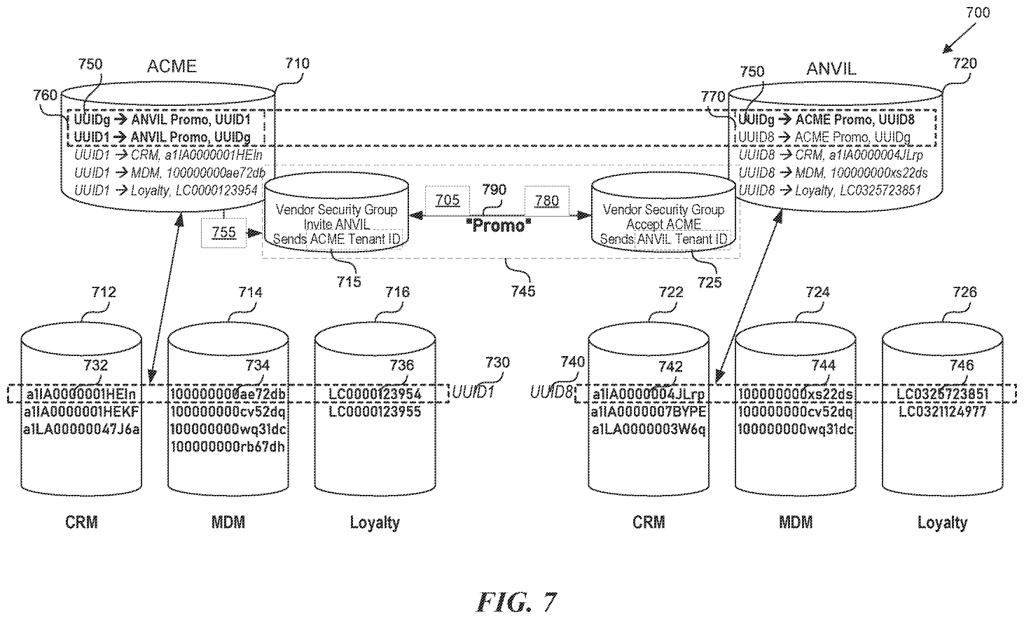

FIG. 7 shows a system to enable secure communication between two or more disparate databases. The system 700 can include two or more systems 710, 720, and a communication module 745 facilitating secure communication between the two or more systems 710, 720.

Each system 710, 720 can include one or more databases 712, 714, 716, and 722, 724, 726 respectively. The one or more databases 712, 714, 716, 722, 724, 726 can include a UUID 730, 740 local to each system 710, 720, respectively. However, the systems 710, 720 do not share their local UUID 730, 740 with each other. The local UUID 730, 740 can correspond to the local IDs 732, 734, 736, 742, 744, 746 as shown in FIG. 7. The UUID 730, 740 correspond to equivalent records. The equivalent records describe the same or related users, same or related events, same or related transactions, etc.

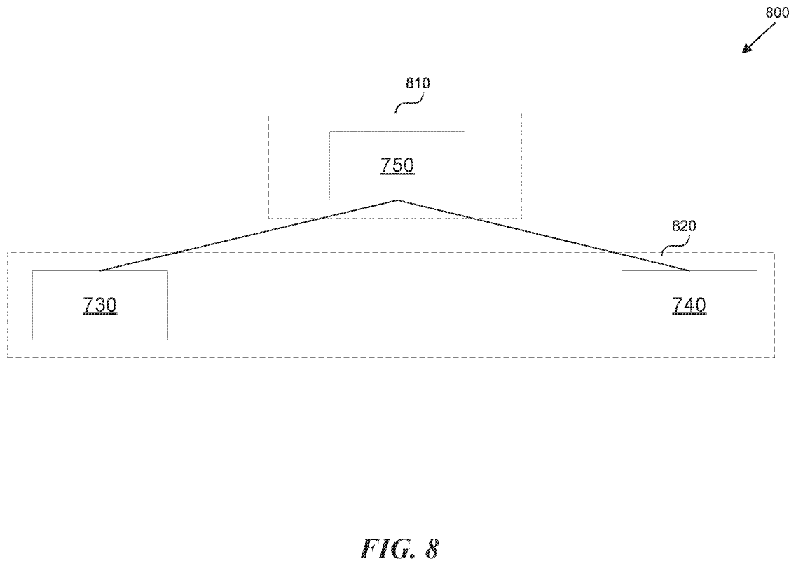

The communication module 745 facilitates interaction between the systems 710, 720 by creating a global UUID 750. The global UUID 750 and the local UUIDs in effect create a hierarchy 800 (see FIG. 8) of UUIDs, where the top level 810 of the hierarchy 800 corresponds to the UUID 750, and the bottom level 820 of the hierarchy 800 corresponds to the UUID 730, 740. The mapping 760 between the global UUID 750 and the local UUID 730 is stored in the system 710, while the mapping 770 between global UUID 750 and the local UUID 740 is stored in the system 720. When the system 710 wants to communicate with the system 720, the system 710 can send the global UUID 750 without communicating the local UUID 730, 740 to the system 720. The system 720 can obtain the local UUID 740 based on the mapping 770, retrieve information associated with the records denoted by local IDs 742, 744, 746, and send the requested information without disclosing the local UUID 740.

The two systems 710, 720 can communicate via the communication module 745 as an intermediary. The communication module 745 can translate the global UUID 750 to the local UUIDs 730, 740. Further, the communication module 740 can create the global UUID 750, the local UUID 730, 740, and the mapping between the global UUID and the local UUIDs.

To establish the communication between the two systems 710, 720, the system 710 can send invitation 780 to the system 720 to share system IDs 715, 725 associated with the communication module 745. Once the systems 710, 720 exchange the system IDs 715, 725, the system 710 can send an invitation to the system 720. Once the system 720 accepts the invitation, the communication channel 790 is established. The system IDs 715, 725 are unique to each system 710, 720 respectively in the communication module 745.

The system 720 can use the communication channel 790 to provide advertisements associated with the system 720. For example, the system 720 can be Nike, and can provide advertisements for sportswear and shoes. The system 710 can be an REI selling outdoor equipment and camping gear. When a user interacts with the system 710, such as through a webpage, the system 710 can retrieve the local UUID 730 associated with the user, and determine that this user may be interested in the advertisements associated with the system 720. Consequently, the system 710 can present the advertisement provided through the communication channel 790 to the user.

Optionally, the user can provide identifying information 705 such as the user's loyalty number or user's login associated with the system 720. The system 710 can send the identifying information 705 to the system 720. In that case, the system 720 can retrieve the local UUID 740 associated with the identifying information 705, and can create the mapping 770 between the UUID 750 and the local UUID 740. If the system 710 does not send the identifying information 705 to the system 720, the system 720 can create a new record and a new UUID 750 associated with the new record, and create the mapping 770 between the UUID 750 in the local UUID 740. The system 720 can use the communication channel 790 to specify what types of users the system 710 can target when presenting advertisements from system 720, such as user demographics, user purchase information, web browsing history, etc.

The communication channel 790 can enable one-way communication such as system 710 placing advertisements from system 720, or two-way communication, where both systems place each other's advertisements.

The communication module 745 can receive from system 720 a request 755 to communicate with system 720. The request can include the UUID 750 and/or the local UUID 730. Optionally, the requesting can include identifying information 705.

The communication module 745 can check whether the UUID 750 exists inside the communication module. If the request does not include the UUID 750 and only includes the local UUID 730, the communication module 745 can check whether the local UUID 730 has a corresponding UUID 750 inside the communication module. If the communication module 745 has the UUID 750 corresponding to the local UUID 730, the communication module can return the UUID 750 to the system 710, or the communication module 745 can send a confirmation that the UUID 750 exists. The communication module 745 does not include the UUID 750 corresponding to the local UUID 730, the communication module can create to the UUID 750, and map the local UUID 730 to the UUID 750, which the system 710 can store as the mapping 760.

The communication module 745 can check whether the UUID 750 exists in system 720. If the UUID 750 does not exist in system 720, the communication module 745 can create or cause the system 720 to create the local UUID 740 and mapping 770 between the UUID 750 and the local UUID 740.

If the communication module 745 receives identifying information 705, the communication module 745 can obtain the local UUID 740 from the system 720 and can create or can cause the system 720 to create the mapping 770 between the UUID 750 and the local UUID 740 without creating a new UUID.

The systems 710, 720 can communicate with each other and request information about the history of information exchanged via the communication channel 790. The communication channel 790 can be dedicated to a particular advertising campaign, or a particular transaction between the systems 710 and 720. For example, the system 710 can request from the communication module 745 or the system 720 the list of all UUIDs 750 involved with the communication channel 790. In addition, the system 710 can request from the system 720 the details of all the local records associated with the list of all UUID 750 involved with the communication channel 790. The details of the local records can include information such as demographics, purchase information, web browsing history, etc.

The security is maintained between the system 710 and system 720 because the two systems communicate via the communication module 745 and the local UUIDs 730, 740 are not shared between the two systems. The two systems 710, 720 may not call each other's application programming interface (API) functions. Either system 710 or system 720 can unilaterally terminate the communication channel 790.

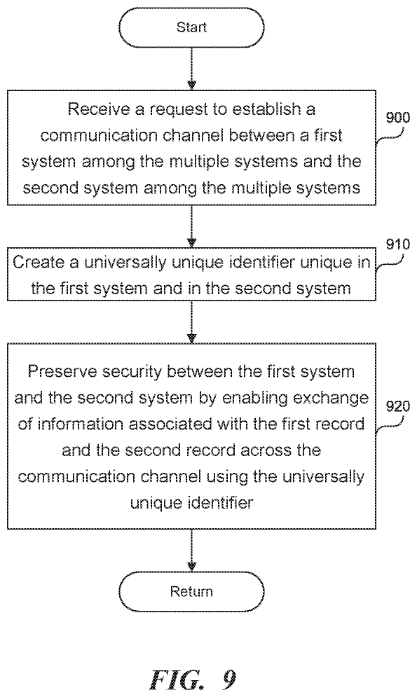

FIG. 9 is a flowchart of a method to enable communication between multiple systems. A hardware or software processor executing instructions described this in application can, in step 900, receive a request to establish a communication channel between a first system among the multiple systems and the second system among the multiple systems. Each system can have a unique ID, or a tenant number, within the communication channel.

The first system among the multiple systems includes a first record associated with a first universally unique identifier, where the first universally unique identifier is unknown to the second system. The first universally unique identifier uniquely identifies a record among one or more databases associated with the first system.

The second system among the multiple systems includes a second record associated with a second universally unique identifier, where the second universally unique identifier is unknown to the first system. The second universally unique identifier uniquely identifies a record among one or more databases associated with the second system. The first record and the second record are equivalent, meaning that the two records refer to the same person, the same event, or the same transaction.

In step 910, the processor can create a universally unique identifier unique in the first system and the second system, where a first mapping between the universally unique identifier and the first universally unique identifier is stored in the first system and a second mapping between the universally unique identifier and the second universally unique identifier is stored in the second system. The processor can create a hierarchy, as shown in FIG. 8, of the various universally unique identifiers. The first level of the hierarchy can include the universally unique identifier, and the second level of the hierarchy can include the first universally unique identifier of the first system, and the second universally unique identifier of the second system.

In step 920, the processor can preserve security between the first system and the second system by enabling exchange of information associated with the first record and the second record across the communication channel using the universally unique identifier, without disclosing the first universally unique identifier to the second system and the second universally unique identifier to the first system.

The processor can receive the request to establish the communication channel between the first system in the second system, where the request includes the first universally unique identifier. The processor can determine whether the universally unique identifier associated with the first universally unique identifier exists. Upon determining that the universally unique identifier associated with the first universally unique identifier does not exist, the processor can create the universally unique identifier and the first mapping between the universally unique identifier and the first universally unique identifier. The processor can determine whether the request includes an identifier associated with the second record. The identifier can be a loyalty number, or a login associated with the second system. Upon determining that the request includes the identifier associated with the second system, the processor can determine whether the identifier exists in the second system. Upon determining that the identifier does not exist in the second system, the processor can create a record and a second universally unique identifier, where the record is based on the identifier. The processor can create the second mapping between the universally unique identifier and the second universally unique identifier in the second system. The processor can store the second mapping between the universally unique identifier and the second universally unique identifier in the second system.

The processor can receive the request to establish the communication channel between the first system and the second system, where the request includes the first universally unique identifier. The processor can determine whether the universally unique identifier associated with the first universally unique identifier exists. Upon determining that the universally unique identifier associated with the first universally unique identifier does not exist, the processor can create the universally unique identifier and the mapping between the universally unique identifier and the first universally unique identifier. The processor can determine whether the universally unique identifier exists in the second system. Upon determining that the universally unique identifier does not exist in the second system, the processor can create the second mapping between the universally unique identifier and the second universally unique identifier. If the universally unique identifier exists in the second system, the processor does not have to do anything. Further, the processor can create a hierarchy between the universally unique identifier, the first universally unique identifier, and the second universally unique identifiers described in this application.

The processor can receive a request to establish the communication channel between the first system and the second system, where the request includes the first universally unique identifier. The processor can determine whether the universally unique identifier associated with the first universally unique identifier exists. Upon determining that the universally unique identifier associated with the first universally unique identifier does not exist, the processor can create the universally unique identifier and the mapping between the universally unique identifier and the first universally unique identifier.

The processor can receive a request to establish the communication channel between the first system and the second system, where the request includes the first universally unique identifier. The processor can obtain the universally unique identifier and the first mapping between the universally unique identifier and the first universally unique identifier. The processor can determine whether the request includes an identifier associated with the second record. The identifier can be a loyalty number, or a login associated with the second system. Upon determining that the request includes the identifier associated with the second system, the processor can determine whether the identifier exists in the second system. Upon determining that the identifier exists in the second system, the processor can obtain the second universally unique identifier associated with a second record. The processor can determine whether the universally unique identifier exists in the second system. Upon determining that the universally unique identifier does not exist in the second system, the processor can create the second mapping between the second universally unique identifier and the universally unique identifier. The processor can store the second mapping between the universally unique identifier and the second universally unique identifier in the second system.

The processor can facilitate secure communication between the first system in the second system. The processor can convert the first universally unique identifier associated with the first record to the universally unique identifier. The processor can send the request to the second system including the universally unique identifier. The processor can convert the universally unique identifier to the second universally unique identifier. The processor can obtain information contained in the second record. The processor can send information contained in the second record to the first system, without communicating the local unique identifiers between the two systems.

The processor can create a central universally unique identifier index, where the central universally unique identifier index maps multiple local identifiers associated with multiple records in multiple databases to the first universally unique identifier. The multiple databases can be associated with one or more systems among the multiple systems. The universally unique identifier is unique across the multiple databases. The multiple databases include a first database without a first universally unique identifier index. The first database among the multiple databases includes a record having a first identifier. A second database among the multiple databases includes an equivalent record having a second identifier. The first identifier and the second identifier are different. The equivalent record in the second database includes information about a same event as the record in the first database. The first universally unique identifier in the central universally unique identifier index relates the first identifier and the second identifier. The first database can belong to the first system, while the second database can belong to the second system as described in this application.

The processor can receive a request from the first database among the multiple databases to obtain the equivalent record from the second database among the multiple databases, where the request includes the first identifier associated with the record in the first database. The processor can determine whether the first identifier is a local identifier unique to the first database. Upon determining that the first identifier is the local identifier unique to the first database, based on the central universally unique identifier index, the processor can convert the local identifier to the first universally unique identifier. The processor can send the universally unique identifier to the first database.

### Computer System

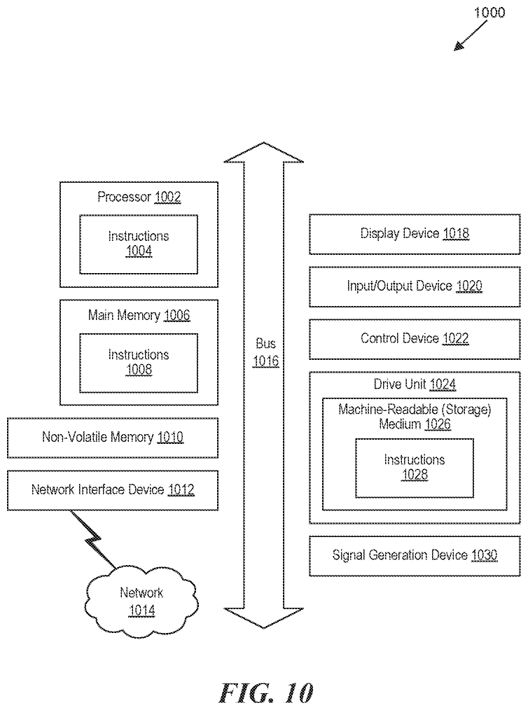

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, video display device 1018, an input/output device 1020, a control device 1022 (e.g., keyboard and pointing device), a drive unit 1024 that includes a storage medium 1026, and a signal generation device 1030 all of which are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the Figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC) or a distributed system such as a mesh of computer systems or include one or more cloud components in one or more networks. Where appropriate, one or more computer systems 1000 can perform operations in real time, near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1006, non-volatile memory 1010, and machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable (storage) medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and, such references can mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. At least one computer-readable storage medium, excluding transitory signals and carrying instructions to enable communication between multiple systems, which, when executed by at least one data processor of a system, cause the system to:
receive a request to establish a communication channel between a first system among the multiple systems and a second system among the multiple systems,
wherein the first system among the multiple systems includes a first record associated with a first universally unique identifier,
wherein the first universally unique identifier is unknown to the second system, and
wherein the second system among the multiple systems includes a second record associated with a second universally unique identifier,
wherein the second universally unique identifier is unknown to the first system;
wherein the first record and the second record are equivalent,
wherein equivalent records include records referring to the same user;
create a universally unique identifier unique in the first system and the second system,
wherein a first mapping between the universally unique identifier and the first universally unique identifier is stored in the first system and a second mapping between the universally unique identifier and the second universally unique identifier is stored in the second system; and
preserve security between the first system and the second system by enabling exchange of information associated with the first record and the second record across the communication channel using the universally unique identifier, without disclosing the first universally unique identifier to the second system and the second universally unique identifier to the first system.

2. The computer-readable storage medium of claim 1, comprising instructions to:
receive the request to establish the communication channel between the first system and the second system,
wherein the request includes the first universally unique identifier;
determine whether the universally unique identifier associated with the first universally unique identifier exists;
upon determining that the universally unique identifier associated with the first universally unique identifier does not exist, create the universally unique identifier and the first mapping between the universally unique identifier and the first universally unique identifier;
determine whether the request includes an identifier associated with the second record;
upon determining that the request includes the identifier associated with the second system, determine whether the identifier exists in the second system;
upon determining that the identifier does not exist in the second system, create a record and the second universally unique identifier,
wherein the record is based on the identifier;
create the second mapping between the universally unique identifier and the second universally unique identifier in the second system; and
store the second mapping between the universally unique identifier and the second universally unique identifier in the second system.

3. The computer-readable storage medium of claim 1, comprising instructions to:
receive the request to establish the communication channel between the first system and the second system,
wherein the request includes the first universally unique identifier;
determine whether the universally unique identifier associated with the first universally unique identifier exists;
upon determining that the universally unique identifier associated with the first universally unique identifier does not exist, create the universally unique identifier and the first mapping between the universally unique identifier and the first universally unique identifier;
determine whether the universally unique identifier exists in the second system; and
upon determining that the universally unique identifier does not exist in the second system, create the second mapping between the universally unique identifier and the second universally unique identifier.

4. The computer-readable storage medium of claim 1, comprising instructions to:
receive the request to establish the communication channel between the first system and the second system,
wherein the request includes the first universally unique identifier;
determine whether the universally unique identifier associated with the first universally unique identifier exists; and
upon determining that the universally unique identifier associated with the first universally unique identifier does not exist, create the universally unique identifier and the first mapping between the universally unique identifier and the first universally unique identifier.

5. The computer-readable storage medium of claim 1, comprising instructions to:
receive the request to establish the communication channel between the first system and the second system,
wherein the request includes the first universally unique identifier;
obtain the universally unique identifier and the first mapping between the universally unique identifier and the first universally unique identifier;
determine whether the request includes an identifier associated with the second record;
upon determining that the request includes the identifier associated with the second system, determine whether the identifier exists in the second system;
upon determining that the identifier exists in the second system, obtain the second universally unique identifier associated with the second record;
determine whether the universally unique identifier exists in the second system;
upon determining that the universally unique identifier does not exist in the second system, create the second mapping between the second universally unique identifier and the universally unique identifier; and
store the second mapping between the universally unique identifier and the second universally unique identifier in the second system.

6. The computer-readable storage medium of claim 1, comprising instructions to facilitate secure communication between the first system and the second system by:
converting the first universally unique identifier associated with the first record to the universally unique identifier;
sending the request to the second system including the universally unique identifier;
converting the universally unique identifier to the second universally unique identifier;
obtaining information contained in the second record; and
sending the information contained in the second record to the first system.

7. The computer-readable storage medium of claim 1, comprising instructions to:
create a central universally unique identifier index,
wherein the central universally unique identifier index maps multiple local identifiers associated with multiple records in multiple databases to the first universally unique identifier,
wherein the multiple databases are associated with at least one system among the multiple systems,
wherein the first universally unique identifier is unique across the multiple databases,
wherein the multiple databases include a first database without a first universally unique identifier index,
wherein the first database among the multiple databases includes a record having a first identifier,
wherein a second database among the multiple databases includes an equivalent record having a second identifier,
wherein the first identifier and the second identifier are different,
wherein the equivalent record in the second database includes information about a same event as the record in the first database, and
wherein the first universally unique identifier in the central universally unique identifier index relates the first identifier and the second identifier;
receive a request from the first database among the multiple databases to obtain the equivalent record from the second database among the multiple databases,
wherein the request includes the first identifier associated with the record in the first database;
determine whether the first identifier is a local identifier unique to the first database;
upon determining that the first identifier is the local identifier unique to the first database, based on the central universally unique identifier index, convert the local identifier to the first universally unique identifier; and
send the first universally unique identifier to the first database.

8. A system comprising:
at least one hardware processor; and
at least one non-transitory memory storing instructions, which, when executed by the at least one hardware processor, cause the system to:
receive a request to establish a communication channel between a first system among multiple systems and a second system among the multiple systems,
wherein the first system among the multiple systems includes a first record associated with a first universally unique identifier,
wherein the first universally unique identifier is unknown to the second system, and
wherein the second system among the multiple systems includes a second record associated with a second universally unique identifier,
wherein the second universally unique identifier is unknown to the first system;
wherein the first record and the second record are equivalent;
create a universally unique identifier unique in the first system and the second system,
wherein a first mapping between the universally unique identifier and the first universally unique identifier is stored in the first system and a second mapping between the universally unique identifier and the second universally unique identifier is stored in the second system; and
preserve security between the first system and the second system by enabling exchange of information associated with the first record and the second record across the communication channel using the universally unique identifier.

9. The system of claim 8, comprising instructions to:
receive the request to establish the communication channel between the first system and the second system,
wherein the request includes the first universally unique identifier;
determine whether the universally unique identifier associated with the first universally unique identifier exists;
upon determining that the universally unique identifier associated with the first universally unique identifier does not exist, create the universally unique identifier and the first mapping between the universally unique identifier and the first universally unique identifier;
determine whether the request includes an identifier associated with the second record;
upon determining that the request includes the identifier associated with the second system, determine whether the identifier exists in the second system;
upon determining that the identifier does not exist in the second system, create a record and the second universally unique identifier,
wherein the record is based on the identifier;
create the second mapping between the universally unique identifier and the second universally unique identifier in the second system; and
store the second mapping between the universally unique identifier and the second universally unique identifier in the second system.

10. The system of claim 8, comprising instructions to:
receive the request to establish the communication channel between the first system and the second system,
wherein the request includes the first universally unique identifier;
determine whether the universally unique identifier associated with the first universally unique identifier exists;
upon determining that the universally unique identifier associated with the first universally unique identifier does not exist, create the universally unique identifier and the first mapping between the universally unique identifier and the first universally unique identifier;
determine whether the universally unique identifier exists in the second system; and
upon determining that the universally unique identifier does not exist in the second system, create the second mapping between the universally unique identifier and the second universally unique identifier.

11. The system of claim 8, comprising instructions to:
receive the request to establish the communication channel between the first system and the second system,
wherein the request includes the first universally unique identifier;
determine whether the universally unique identifier associated with the first universally unique identifier exists; and
upon determining that the universally unique identifier associated with the first universally unique identifier does not exist, create the universally unique identifier and the first mapping between the universally unique identifier and the first universally unique identifier.

12. The system of claim 8, comprising instructions to:
receive the request to establish the communication channel between the first system and the second system,
wherein the request includes the first universally unique identifier;
obtain the universally unique identifier and the first mapping between the universally unique identifier and the first universally unique identifier;
determine whether the request includes an identifier associated with the second record;
upon determining that the request includes the identifier associated with the second system, determine whether the identifier exists in the second system;
upon determining that the identifier exists in the second system, obtain the second universally unique identifier associated with the second record;
determine whether the universally unique identifier exists in the second system;
upon determining that the universally unique identifier does not exist in the second system, create the second mapping between the second universally unique identifier and the universally unique identifier; and
store the second mapping between the universally unique identifier and the second universally unique identifier in the second system.

13. The system of claim 8, comprising instructions to facilitate secure communication between the first system and the second system by:
converting the first universally unique identifier associated with the first record to the universally unique identifier;
sending the request to the second system including the universally unique identifier;
converting the universally unique identifier to the second universally unique identifier;
obtaining information contained in the second record; and
sending the information contained in the second record to the first system.

14. The system of claim 8, comprising instructions to:
create a central universally unique identifier index,
wherein the central universally unique identifier index maps multiple local identifiers associated with multiple records in multiple databases to the first universally unique identifier,
wherein the multiple databases are associated with at least one system among the multiple systems,
wherein the first universally unique identifier is unique across the multiple databases,
wherein the multiple databases include a first database without a first universally unique identifier index,
wherein the first database among the multiple databases includes a record having a first identifier,
wherein a second database among the multiple databases includes an equivalent record having a second identifier,
wherein the first identifier and the second identifier are different,
wherein the equivalent record in the second database includes information about a same event as the record in the first database, and
wherein the first universally unique identifier in the central universally unique identifier index relates the first identifier and the second identifier;
receive a request from the first database among the multiple databases to obtain the equivalent record from the second database among the multiple databases,
wherein the request includes the first identifier associated with the record in the first database;
determine whether the first identifier is a local identifier unique to the first database;
upon determining that the first identifier is the local identifier unique to the first database, based on the central universally unique identifier index, convert the local identifier to the first universally unique identifier; and
send the first universally unique identifier to the first database.

15. A method comprising:
receiving a request to establish a communication channel between a first system among multiple systems and a second system among the multiple systems,
wherein the first system among the multiple systems includes a first record associated with a first universally unique identifier,
wherein the first universally unique identifier is unknown to the second system, and
wherein the second system among the multiple systems includes a second record associated with a second universally unique identifier,
wherein the second universally unique identifier is unknown to the first system;
wherein the first record and the second record are equivalent;
creating a universally unique identifier unique in the first system and the second system,
wherein a first mapping between the universally unique identifier and the first universally unique identifier is stored in the first system and a second mapping between the universally unique identifier and the second universally unique identifier is stored in the second system; and
preserving security between the first system and the second system by enabling exchange of information associated with the first record and the second record across the communication channel using the universally unique identifier.

16. The method of claim 15, comprising:
receiving the request to establish the communication channel between the first system and the second system,
wherein the request includes the first universally unique identifier;
determining whether the universally unique identifier associated with the first universally unique identifier exists;
upon determining that the universally unique identifier associated with the first universally unique identifier does not exist, creating the universally unique identifier and the first mapping between the universally unique identifier and the first universally unique identifier;
determining whether the request includes an identifier associated with the second record;
upon determining that the request includes the identifier associated with the second system, determining whether the identifier exists in the second system;
upon determining that the identifier does not exist in the second system, creating a record and the second universally unique identifier,
wherein the record is based on the identifier;
creating the second mapping between the universally unique identifier and the second universally unique identifier in the second system; and
storing the second mapping between the universally unique identifier and the second universally unique identifier in the second system.

17. The method of claim 15, comprising:
receiving the request to establish the communication channel between the first system and the second system,
wherein the request includes the first universally unique identifier;
determining whether the universally unique identifier associated with the first universally unique identifier exists;
upon determining that the universally unique identifier associated with the first universally unique identifier does not exist, creating the universally unique identifier and the first mapping between the universally unique identifier and the first universally unique identifier;
determining whether the universally unique identifier exists in the second system; and
upon determining that the universally unique identifier does not exist in the second system, creating the second mapping between the universally unique identifier and the second universally unique identifier.

18. The method of claim 15, comprising:
receiving the request to establish the communication channel between the first system and the second system,
wherein the request includes the first universally unique identifier;
determining whether the universally unique identifier associated with the first universally unique identifier exists; and
upon determining that the universally unique identifier associated with the first universally unique identifier does not exist, creating the universally unique identifier and the first mapping between the universally unique identifier and the first universally unique identifier.

19. The method of claim 15, comprising:
receiving the request to establish the communication channel between the first system and the second system,
wherein the request includes the first universally unique identifier;
obtaining the universally unique identifier and the first mapping between the universally unique identifier and the first universally unique identifier;
determining whether the request includes an identifier associated with the second record;
upon determining that the request includes the identifier associated with the second system, determining whether the identifier exists in the second system;
upon determining that the identifier exists in the second system, obtaining the second universally unique identifier associated with the second record;
determining whether the universally unique identifier exists in the second system;
upon determining that the universally unique identifier does not exist in the second system, creating the second mapping between the second universally unique identifier and the universally unique identifier; and
storing the second mapping between the universally unique identifier and the second universally unique identifier in the second system.

20. The method of claim 15, comprising facilitating secure communication between the first system and the second system by:
converting the first universally unique identifier associated with the first record to the universally unique identifier;
sending the request to the second system including the universally unique identifier;
converting the universally unique identifier to the second universally unique identifier;
obtaining information contained in the second record; and
sending the information contained in the second record to the first system.
